(19) United States
(12) Patent Application Publication
(10) Pub. No.: US 2009/0197977 A1
(43) Pub. Date: Aug. 6, 2009

(54) Device and Method for Producing a Mixture of Two Phases that are Insoluble in Each Other

(76) Inventors: Stefan Haeberle, St. Georgen (DE); Jens Ducree, Freiburg (DE); Roland Zengerle, Waldkirch (DE)

Correspondence Address: GLENN PATENT GROUP, 3475 EDISON WAY, SUITE L, MENLO PARK, CA, 94025, US

(21) Appl. No.: 12/089,035

(22) PCT Filed: Sep. 19, 2006
(86) PCT No.: PCT/EP2006/009099

§ 371 Date: Sep. 5, 2008

(30) Foreign Application Priority Data
Oct. 7, 2005 (DE) 10 2005 048 259.7

(51) Int. Cl. B01J 13/00; B01F 15/02; B01F 15/04; B01F 3/04; B65B 3/04

(52) U.S. Cl. 516/10; 366/173.1; 366/160.1; 366/159.1; 261/74; 516/9; 141/105

(57) ABSTRACT

A device for producing a mixture of two phases that are insoluble in each other comprises a first fluid channel and a second fluid channel which lead into a contact region. Also, a third fluid channel is provided which leads into the contact region. The device comprises an imparter configured to impart a rotation on the fluid channels, a first phase being centrifugally supplied to the contact region through the first fluid channel, and a second phase, insoluble in the first phase, being supplied to the contact region through the second fluid channel, compressive and/or shearing forces in the contact region which are centrifugally/hydrodynamically induced by the rotation causing drops to break away in one of the phases supplied in order to produce the mixture of the first and second phases.

### TECHNICAL FIELD

The present invention relates to a device and a method for producing a mixture of two phases that are insoluble in each other, for example of emulsions or foams.

### BACKGROUND

Emulsification is a central step in a plurality of production processes in the fields of food industry, cosmetic industry and pharmaceutical industry. For emulsification, two liquids that are insoluble in each other, for example oil and water, are mixed so as to produce a mixture wherein one liquid is distributed in the other in the form of small droplets.

Equipment used for producing emulsions may be classified into two large groups, namely turbulence-inducing systems and systems with controlled drop generation.

With regard to the turbulence-induced systems, for example rotor/stator systems are used, for industrial application, wherein a rotor is used to stir the liquids so as to produce the mixture. Such systems are available, for example, from Microtec Co., Ltd. (http://nition.com/en). In addition, high-pressure homogenizers, for example from Niro Inc. (http://www.niroinc.com”), or ultrasound-based systems, e.g. Dr. Hielscher GmbH (http://www.hielscher.com), are used. This equipment may be used universally for dispersing several immiscible phases. To this end, high shearing forces are induced in the phase boundaries so as to achieve a mixture. With this method, however, the size distribution of the disperse phase strongly varies since stochastically distributed break-away effects in turbulent flows are responsible for the drop generation. A further disadvantage of these mechanical dispersing processes is the energy input into the phase mixture. Because of it, the temperature of the emulsion is increased, and heat-sensitive components as are often found in pharmaceutical production may be destroyed.

The disadvantages of the turbulence-inducing systems, namely wide drop size distribution as well as a temperature rise in the emulsion, may be circumvented by systems wherein structures of the order of magnitude of the drops to be produced are employed for geometrically controlled drop generation.

A known example of producing monodisperse emulsions is a membrane reactor as is disclosed, for example, by Fraunhofer Institut für Grenzflächen und Bioverfahrenstechnik (http://www.igb.fraunhofer.de). An example of such a membrane reactor is depicted in FIG. 1, where a continuous phase 10 is passed through two porous membranes 12 and 14, through the micropores 16 of which a phase 18 to be dispersed is pressed into the continuous phase. When exiting the pores 16, the disperse phase is then sheared off from the continuous phase flowing perpendicular to it, and drops 20 are formed. In this manner, an emulsion 22 is produced from the continuous phase 10 and the disperse phase 18.

Recently, the production of stable microemulsions, which comprise distributions with small droplet sizes, by microfluidic systems has been disclosed, see T. Thorsen, R. W. Roberts, F. H. Arnold and S. R. Quake, Phys. Rev. Lett. 86, pp. 4.163-4.166 (2001). The creation of double emulsions by microfluidic systems has also been disclosed, see A. S. Utada, E. Lorenceau, D. R. Link, P. D. Kaplan, H. A. Stone, D. A. Weitz, Science, 308, pp. 537-541 (2005). In the event that the droplet size is adjusted to the range of the channel dimensions, a continuous flow is subdivided into separate liquid departments, each of which represents a minute reaction vessel, where fast diffuse and even convection-aided mixing occurs, see A. Günther, M. Jhunjhunwala, M. Thalmann, M. A. Schmidt and K. F. Jensen, Langmuir, 21, pp. 1.547-1.555 (2005), and L. S. Roach, H. Song, R. F. Ismagilov, Anal. Chem., 77, pp. 785-796 (2005).

By means of such methods, it is possible to produce emulsions comprising a very narrow-band distribution of the drop sizes, so-called monodisperse emulsions.

Such sub-millimeter range fluidic structures produced by means of microtechnology, referred to as microfluidic systems, enable controlled production and manipulation of individual drops, so that emulsions comprising a very narrow-band distribution of the drop sizes and, thus, highly monodisperse emulsions may be produced.

T. Nisiako, T. Toru and H. Toshiro, “Rapid Preparation Of Monodispersed Droplets With Confluent Laminar Flows”, in Proceedings of the sixteenth annual international conference on micro electro mechanical systems—MEMS 2003, pp. 331-334, describe a T-shaped channel structure as is depicted in FIG. 2. A first phase 30, as a continuous phase, is passed to a junction 34 through a first fluid channel 32, while a second phase 38 is passed, as a disperse phase, to the junction 34 through a further fluid channel 36. Syringes and syringe pumps are used for supplying the phases. Due to the specific hydrodynamic conditions, for example the high shearing forces, which are present in the microchannels, a sequence of drop breakaways of the disperse into the continuous phases occur at the contacting point, so that in an outlet channel 40, an emulsion is produced from the first and second phases.

Q. Y. Xu and M. Nakajima, “The generation of highly monodisperse droplets through the breakup of hydrodynamically focused microthread in a microfluidic device”, Applied Physics Letters, vol. 85, no. 17, pp. 3.726-3.728, 2004, disclose an alternative channel structure for droplet generation. Such a channel structure is depicted in FIG. 3 and comprises a central channel 42, via which a disperse phase, for example soybean oil, is supplied, as well as two lateral channels 44 and 46, via which a continuous phase, for example an SDS solution (sodium dodecyl sulphate), is supplied. For supplying the phases, micro syringe pumps are used for pumping the disperse phase and the continuous phase. Again due to the specific hydrodynamic conditions present within the microchannels, controlled breakaway of drops of the disperse phase into the continuous phase in the downstream fluid region occurs at the junction of the three channels 42, 44 and 46, where contact between the phases supplied occurs.

For the physical principles of droplet formation in the channels shown in FIGS. 2 and 3, reference shall be made to the above-mentioned publications of Nisiako and Xu.

Irrespective of the methods mentioned for producing emulsions, one has known microfluid systems which use centrifugal forces for handling liquids, see J. Ducrée, H-P. Schlosser, S. Haeberle, T. Glatzel, T. Brenner, R. Zengerle, Proc. of μTAS 2004, Malmö, Sweden, pp. 554-556. Droplet-based analytical chemistries and corresponding microprocessing techniques are further described, for example, by S. Okushima, T. Nisisako, T. Torii, T. Higuchi, Proc. of μTAS 2004, Malmö, Sweden, pp. 258-260.

### SUMMARY

According to an embodiment, a device for producing a mixture of two phases that are insoluble in each other may have: a first fluid channel leading into a contact region; a second fluid channel leading into the contact region; a third fluid channel leading into the contact region; and a rotation imparter configured to impart a rotation on the first fluid channel, the second fluid channel and the third fluid channel, a first phase being centrifugally supplied to the contact region through the first fluid channel, and a second phase, insoluble in the first phase, being supplied to the contact region through the second fluid channel, compressive and/or shearing forces in the contact region which are centrifugally/hydrodynamically induced by the rotation causing drops to break away in one of the phases supplied in order to produce the mixture of the first and second phases.

According to another embodiment, a method for producing a mixture of two phases that are insoluble in each other may have the steps of: centrifugally supplying a first phase to the contact region through a first fluid channel; supplying a second phase to a contact region through a second fluid channel, the centrifugal supplying being effected by a rotation of the first fluid channel, the second fluid channel and the contact region, compressive and/or shearing forces in the contact region which are centrifugally/hydrodynamically induced by the rotation causing drops to break away in one of the phases supplied in order to produce the mixture of the first and second phases; and centrifugally draining off the mixture from the contact region through a third fluid channel.

The present invention provides a device for producing a mixture of two phases that are insoluble in each other, comprising:

a first fluid channel leading into a contact region;

a second fluid channel leading into the contact region;

a third fluid channel leading into the contact region; and

means configured to impart a rotation on the first fluid channel, the second fluid channel and the third fluid channel, a first phase being centrifugally supplied to the contact region through the first fluid channel, and a second phase, insoluble in the first phase, being supplied to the contact region through the second fluid channel, compressive and/or shearing forces in the contact region which are centrifugally/hydrodynamically induced by the rotation causing drops to break away in one of the phases supplied in order to produce the mixture of the first and second phases.

The present invention further provides a method for producing a mixture of two phases that are insoluble in each other, comprising:

centrifugally supplying a first phase to a contact region through a first fluid channel;

supplying a second phase to the contact region through a second fluid channel,

the centrifugal supplying being effected by a rotation of the first fluid channel, the second fluid channel and the contact region, compressive and/or shearing forces in the contact region which are centrifugally/hydrodynamically induced by the rotation causing drops to break away in one of the phases supplied in order to produce the mixture of the first and second phases; and

centrifugally draining off the mixture from the contact region through a fluid channel.

As compared to known methods, the present invention is thus based on exploitation of the centrifugal force so as to contact at least two immiscible phases in a rotating system to produce emulsions, if the two phases are liquids. Here, liquid phases are supplied to the contact region in a centrifugal manner by means of the rotation.

In accordance with the invention, foams, for example monodisperse liquid/gas phase dispersions, may also be produced if one phase is a liquid, and one phase is a gas. Supplying a gas phase to a liquid phase is not possible directly by means of centrifugal pumping, since in the presence of the liquid phase, which is considerably more dense, the gas phase would be pumped radially inward instead of outward. In order to produce liquid/gas dispersions, embodiments of the invention therefore provide for a means which enable supplying the gas via the associated fluid channel(s). Such means could be formed, for example, by a co-rotating pump (on-board pump). In addition, the gas could be sucked in, in accordance with the waterjet pump principle, at high speed of the liquid flow at a radially outer location of the channel.

Thus, the present invention addresses the production of drops or emulsions in rotating channels, and the processing of immiscible phases in rotating modules. In accordance with the invention, at least one, and—in the event of two liquids—both phases are transported in fluid channels by centrifugal forces, and the phases are joined at at least one location, drops breaking away in a controlled manner from at least one phase. This process may occur in a repeated manner, serially or in parallel.

The inventive pumping by means of the centrifugal force enables continuous operation, i.e. a pulse-free field of force on the interacting fluids. Here, the rotational frequency in the continuous rotary motion is stabilized as against speed variations of the drive via the rotor's moment of inertia. In this manner, oscillations as occur in a drive by means of syringe pumps or positive-displacement pumps are avoided.

This ensures consistent conditions for all drop breakaway processes, and, thus reproducibility of the processes or the drops produced. Here, pumping of highly viscous media by means of the centrifugal force is also possible. In advantageous embodiments, the phases are continually apportioned into an inlet region of the fluid channels, it being possible for such an inlet region to be formed, for example, by a reservoir on a top face of a rotor. Via suitable guidance structures within the rotor, the liquids may then be fed to closed channels which represent the fluid channels whose radially outer ends lead into the contact region. Further embodiments of the invention may comprise continual, radial ejection of the processed liquid from the rotor into a collector. Alternatively, the liquid may be collected within a cavity on the rotor, possibly in combination with targeting draining off of same. Thus, no pressure-tight fluid interfaces are needed in accordance with the invention, since media to be processed may be led into the process module in an open jet, and may possibly be led out of same.

In advantageous embodiments, the inventive channel structure includes three supply channels in the form of a sheath-flow structure, wherein the phase to be dispersed is contacted, at a contacting point, with the continuous phase from two opposite sides. In addition, the present invention enables the production of multi-phase drops, at least two miscible or immiscible phases being included in one drop. To achieve this, a mixture of two miscible or immiscible phases may be supplied via one of the supply channels. The production of 2-phase drops is possible, in accordance with the sheath-flow principle, also by means of adding further inflow channels, which provide further phase boundaries in the contacting region. In addition, double emulsions may also be produced in accordance with the sheath-flow principle in that still further phases are added to the contacting region in, for example, two further supply channels. These may serve, for example, to encapsulate an inner phase from the continuous medium (vesicle).

The channel structures necessary for implementing the invention may be formed either directly within a rotor, for example a disc, or may be formed within a module inserted into a rotor. Further processing of the drops on the rotor, or the rotating module, for example repeated splitting of the drops, is also possible. In addition, new process sequences may be enabled by means of integrated extraction of the phases, for example by means of sedimentation and/or decanting. In addition to producing emulsions, the present invention also enables producing dispersions of gasses and liquids, i.e. foams.

The inventive utilization of the centrifugal force for producing a mixture of two phases that are insoluble in each other enables precise control and reproducibility of the drop size by means of hydrodynamic boundary conditions specified by geometric structures. In addition, identical structures may be operated in parallel, which leads to a parallelization on the process module. In the invention, there are new “centrifugal” conditions of the drop breakaway, which enables access to new areas of experimental parameters, for example the drop size, the drop frequency, the drop spacing at specified viscosities, densities and surface/interfacial tensions of the liquids to be dispersed. Finally, heat input into the liquids may be fully avoided by centrifugal pumping.

To enable centrifugal transport of liquid, in each case radially outer ends of the channels via which the liquids are supplied to a contact region lead into the contact region, whereas radially inner ends of the channel or channels serving to drain off liquids or a liquid/gas emulsion lead into the contact region. A “radially outer” end is understood to mean an end which is radially further out than another end of the respective channel, so that a centrifugally driven transport of liquids from the other end to the radially outer end is possible. Similarly, a “radially inner” end is understood to mean an end which is radially further in than another end of the respective channel, so that a centrifugally driven transport of liquid is possible from the radially inner end to the other end. These designations thus represent no absolute condition in that the channels could not comprise arches whose arch regions are located, in sections, radially further out or in than the respective confluences, as long as a centrifugal transport of liquid as was described above is possible.

The present invention thus provides a novel centrifugal microfluidic method for continuous production of highly monodisperse mixtures of two phases that are insoluble in each other, for example of water droplets in a flow of oil. The present invention may readily be integrated on centrifugal platforms with further processing methods, for example centrifugal droplet sedimentation, which allows novel applications in the field of droplet-based analysis and microprocessing technology.

### BRIEF DESCRIPTION OF THE DRAWINGS

Embodiments of the present invention will be detailed subsequently referring to the appended drawings, in which:

FIG. 1 shows a membrane reactor in accordance with what has been known so far;

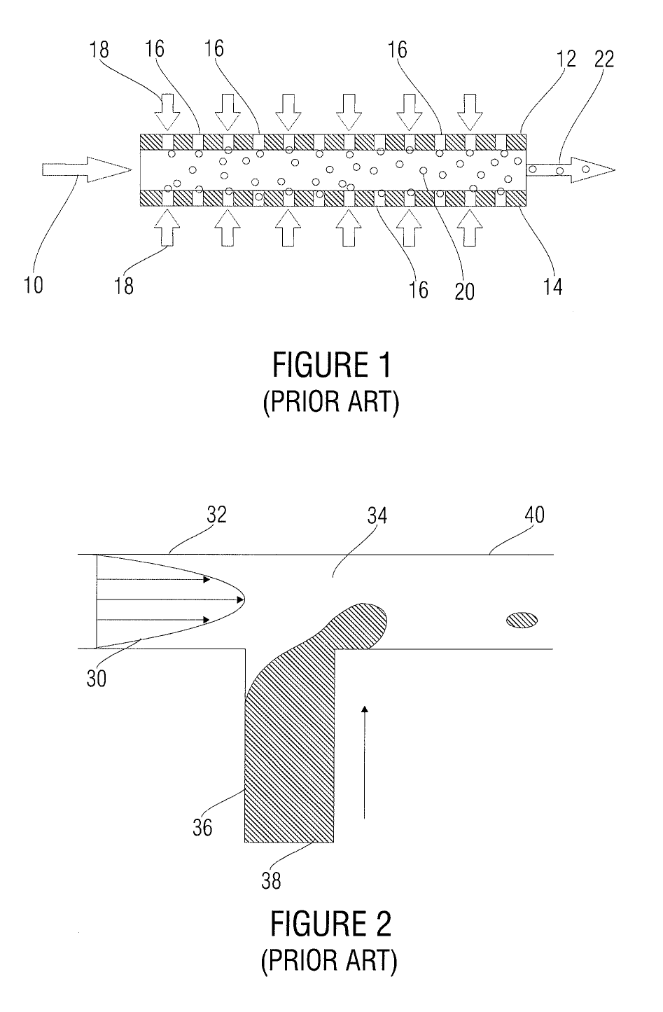

FIGS. 2 and 3 show channel structures in accordance with what has been known so far;

FIG. 4 shows a schematic cross-sectional view of an embodiment of an inventive device;

FIG. 5 shows a schematic top view of a channel structure in accordance with an embodiment of the present invention;

FIGS. 6 to 8 show schematic representations for illustrating the functionality of the present invention; and

FIG. 9 shows experimental results of an implementation of the invention.

### DETAILED DESCRIPTION

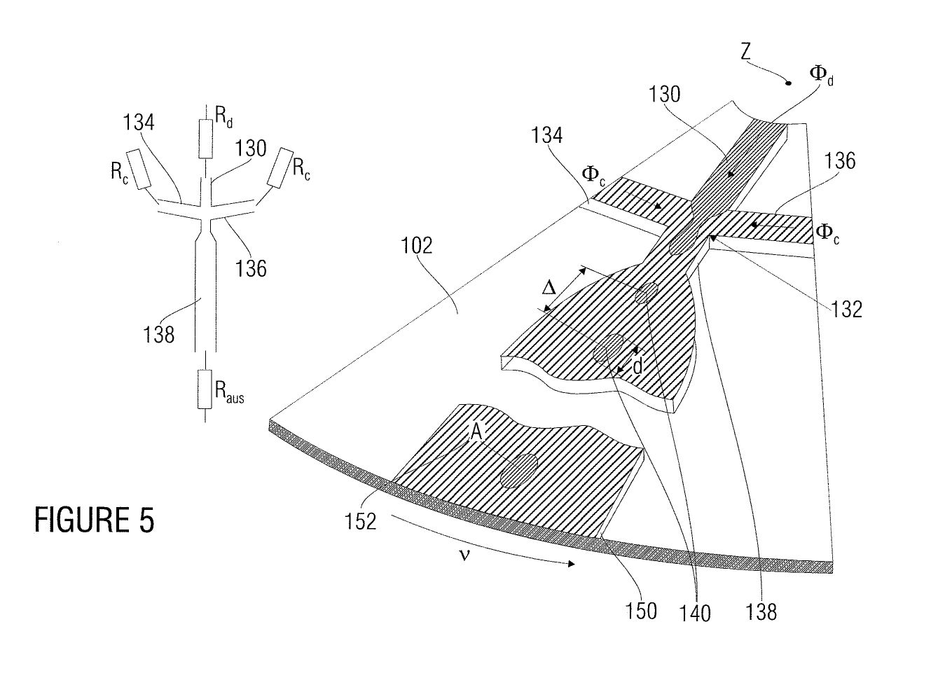

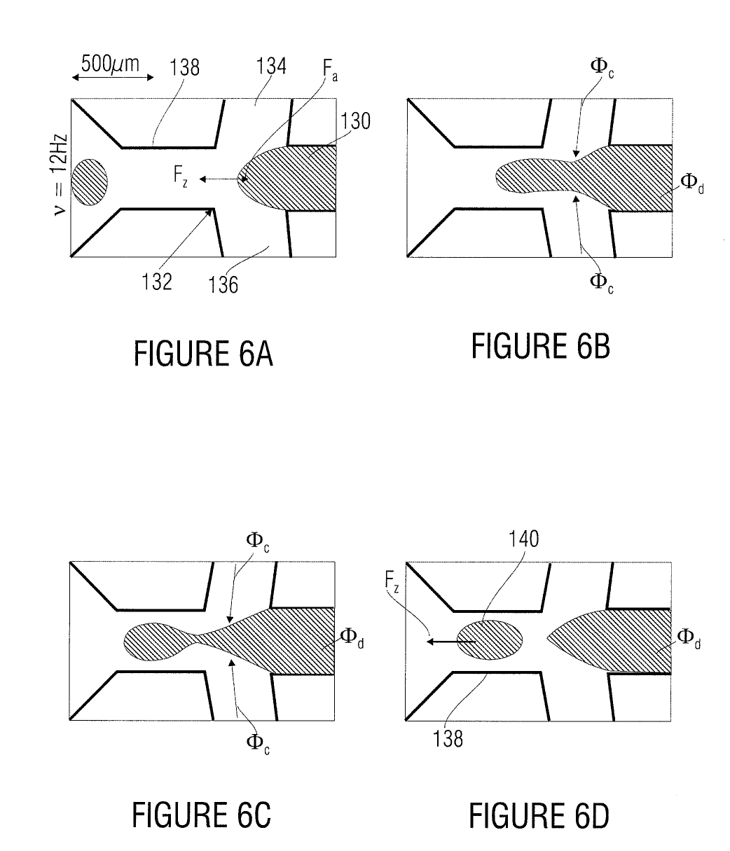

With reference to FIG. 4, the fundamental architecture of an embodiment of the present invention shall be explained below, an exemplary channel structure for producing a mixture of two phases that are insoluble in each other being addressed below in more detail with reference to FIG. 5.

The embodiment of the present invention depicted in FIG. 4 comprises a drive unit 100 formed, for example, by a torque motor comprising an associated controller. The device further comprises a rotational body 102 which is rotatable about an axis of rotation Z by the drive unit 100. The drive unit 100 includes a suitable device for fastening the rotational body 102. The device further comprises a first fluid injection module 104 and a second fluid injection module 106. In addition, a fluid collecting means 108 is provided which surrounds the rotational body 102 in an annular manner.

At least one channel structure enabling creation of a mixture of two phases that are insoluble in each other is provided within the rotational body 102. In advantageous embodiments, however, a plurality of respective channel structures 110 are advantageously provided which are arranged, within the rotational body, in a star-shaped manner and extend outward in a radial manner, and which may be fed via separate or common reservoirs. In the embodiment represented, the rotational body 102 consists of a substrate 102 which may be formed from any suitable material, for example plastic, silicon, glass or the like. The channel structures 110 are structured within the substrate 102. The substrate 102a is provided with a cover 102b comprising openings 112 for fluid connection with fluid reservoirs 114 and 116, which are formed on the rotational body 102. The reservoirs 114 and 116 are formed on the rotational body 102 in an annular manner, so that they enable continuous replenishment via the fluid injection means 104 and 106 during a rotation. In addition, the reservoirs are shaped such that centrifugal overflow is avoided up to a certain rotational speed which should exceed the speed necessitated for the drop production.

The channel structures 110 are open toward the outside in a radial manner so that liquid may be radially ejected from same to the outside into the collector 108 by centrifugal force. The collector 108 may further be provided with suitable outlet means so as to drain off the produced mixture from same, as is indicated by an arrow 120. Also, the dispersion may be collected in a co-rotating reservoir.

During operation, a first liquid is continually introduced into the reservoir 114 by the fluid injection means 104, whereas a second liquid is continually introduced into the reservoir 116 by the fluid injection means 106. The reservoirs 114 and 116 are configured to keep the liquids within the reservoirs during rotation of the rotational body 102 about the axis of rotation Z perpendicular to same. During the rotation of the rotational body 102 about the axis Z, the liquids pass into the channel structures 110 by centrifugal force, supported by gravitational force, where they are driven radially outward by the centrifugal force F_{Z}. At a radially outer end, the fluid channels branching off from the reservoirs 114 and 116 each lead into a contact region into which also a radially inner end of a third fluid channel leads. At the location where the liquids meet within the contact region, compressive and/or shearing forces which are centrifugally/hydrodynamically induced by the rotation cause drops to break away in one of the liquids supplied, so that an emulsion of the two liquids is centrifugally driven outward through the third channel and is ejected into the collector 108 at the radially outer end of the rotational body.

The device described with reference to FIG. 4 thus comprises a drive unit and a process module, the process module consisting of at least two fluid inputs or at least two reservoirs and a microstructured substrate, which may rotate about an axis of rotation Z perpendicular to the substrate surface. The fluid inputs are configured such that continuous supply of several liquid flows during rotation is possible.

In the example depicted in FIG. 4, the fluids are continually ejected from the process module into the collector 108 after processing, and are possibly drained off via suitable means 120. Alternatively, the fluids could be collected in further reservoirs on the module after processing.

In the embodiment depicted in FIG. 4, the channel structures are formed within the rotor 102. Alternatively, the channel structures may be integrated within a channel module which may be inserted into a rotor. The rotor could then comprise, for example, the reservoir structures and/or collector reservoirs and/or structures enabling radial ejection of the fluids processed.

As was set forth, the fluids, in the advantageous embodiment liquids that are insoluble in each other, are fed via vertical collecting channels or openings 112 in the cover 102b on the substrate, and are coupled into the microchannels of the channel structure which causes the creation of an emulsion. During rotation, the fluids are centrifugally transported outward, the phases to be dispersed being transported to a contacting point in separate and differently shaped microchannels.

An embodiment of such a channel structure for inducing a suspension or a mixture of two phases that are insoluble in each other is shown in FIG. 5. More specifically, FIG. 5 schematically shows a portion of the rotor 102 comprising the channel structure for producing a mixture of two phases that are insoluble in each other. The channel structure comprises a fluid channel 130, the radially outer end of which leads into a contacting point or a contacting region 132, as well as two fluid ducts 134 and 136 whose radially outer ends also lead into the contacting region 132. The radially outer ends of the fluid channels 134 and 136 lead into the contact region from two opposite sides with regard to the fluid channel 130, so that the fluid channel 130 is located between the fluid channels 134 and 136. A radially inner end of an outlet channel 138 also leads into the contacting region 132, advantageously opposite the fluid channel 130. The fluid channel 130 is connected, for example, to the reservoir 106 so as to obtain from same the phase to be dispersed. The fluid channels 134 and 136 are connected, for example, to the reservoir 104 so as to obtain from same the continuous phase. During a rotation of the rotor 102, as is indicated by a rotational frequency ν in FIG. 5, a centrifugal flow is induced within the fluid channels 130, 134 and 136. More specifically, the fluid to be dispersed is supplied via a fluid flow Φ_{d} within the fluid channel 130, while the continuous fluid is supplied with a fluid flow Φ_{c} via the channels 134 and 136. The channel structure shown in FIG. 5 represents a so-called sheath-flow structure. The phase Φ_{d} to be dispersed is contacted from both sides with the continuous phases Φ_{c} within the contacting region 132, which induces drops to break away.

The different designs, i.e. lengths and cross-sections, of the channels define the hydrodynamic resistances R_{d} and R_{c} of the supply channels as well as the hydrodynamic resistance Rₒᵤₜ of the drain channel 138, as is indicated on the left-hand side of FIG. 5. By means of these hydrodynamic resistances and of the rotational speed, the flow speeds of the two phases at the contacting point 132 may be controlled. Along with the pulse-free centrifugal pumping, the drop breakaway at the contacting point may thus be controlled with high precision and repeat accuracy.

Merely schematically, in this context FIG. 5 represents two broken-away drops 140 comprising a drop diameter d and a mutual distance Δ.

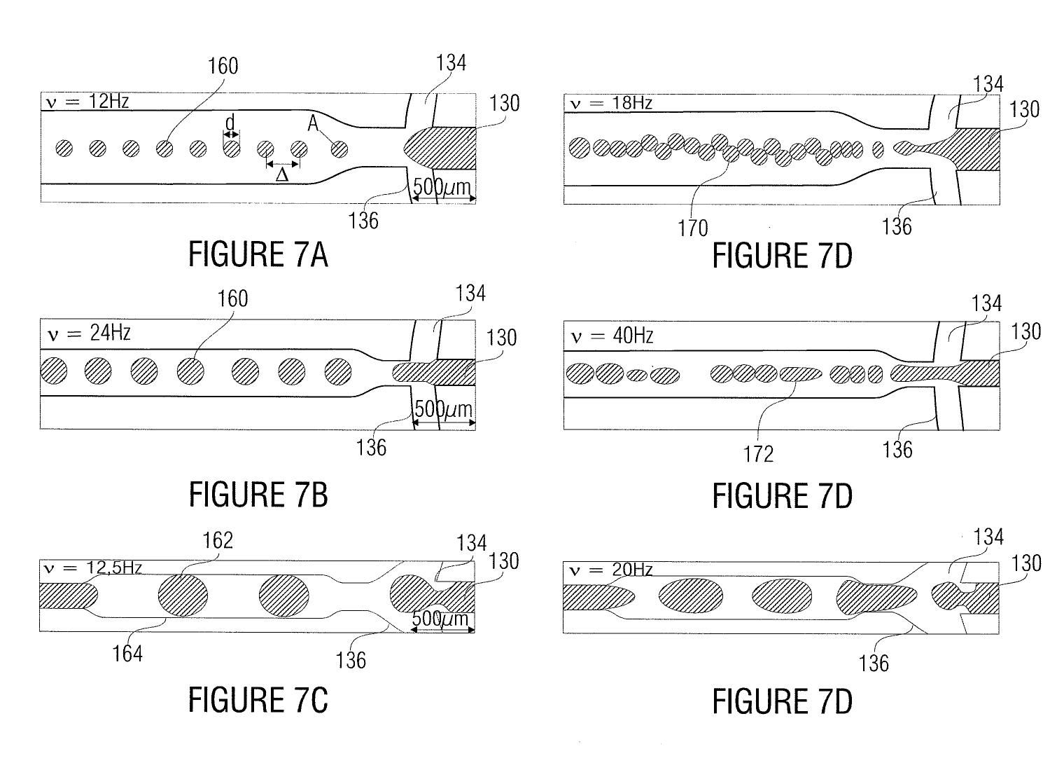

Four phases of the drop breakaway are depicted in a stroboscopic frame sequence in FIGS. 6a-6d. Using water, the sequence was taken up as the phase to be dispersed, and sunflower oil as the continuous phase.

As was described, the disperse phase supplied through the fluid channel 130 by centrifugal force Fᵥ is contacted, from two sides, with flows of the continuous phase supplied by the channels 134 and 136, and is transported into a shared channel 138. This occurs at a defined attack angle so as to achieve a constricting effect of the two side streams on the disperse phase coming from the central channel 130, and so as to promote the breaking away of drops at the contacting point.

In addition to the channel arrangement, the wetting properties of the channels are also significant. The continuous phase Φ_{c}, preferentially wets the channels, as compared to the dispersive phase Φ_{d}. Thus, the dispersive phase must be actively drawn from the central channel 130 by means of the centrifugal force F_{z}. From a specific size of the front of the dispersive phase Φ_{d} projecting into the contacting region, the constricting action of the side streams Φ_{c} and of the interfacial tension between the two phases causes drops to break away, as may be seen in FIGS. 6b-6d. The drop 140 generated is subsequently led in the direction of the outer edge of the rotational body 102, and is ejected through the channel end which is open at this end, via the outlet channel 138 and advantageously a channel region 150, adjacent to same, with a clearly lower flow resistance (see FIG. 5). Alternatively, it may be collected in a reservoir on the rotational body 102, it being possible for an outlet opening to be provided for this purpose, see opening 152 in FIG. 5.

Both the drop size and the type of the multi-phase stream may be adjusted by targeted changes in the geometric parameters of the channel structure and in the rotational frequency. In this respect, FIGS. 7a-7c show different sheath-flow channel structures with respective inlet channels 130, 134 and 136, for operation with different rotational frequencies ν. By varying the geometric parameters and the rotational frequencies, different types of emulsion may be produced. As may be seen from the representations of FIGS. 7a-7c, three different forms of multi-phase streams have been produced. In accordance with FIGS. 7a and 7b, there are isolated droplets 160, i.e. drops which are spatially isolated and are flowing in suspension. In addition, squeezed droplets 162, i.e. droplets abutting the channel walls in the vertical direction, may be produced, as is depicted in FIG. 7c. In addition, it is also possible to produce a segmented flow, i.e. drops abutting the channel walls in the vertical and the horizontal directions (transversely to the flow). This may be supported, for example, in that a tapering is provided downstream in the outlet channel, as is depicted in the left-hand region of the outlet channel 164 in FIG. 7c.

FIGS. 7d-7f, respectively, show the same channels as do FIGS. 7a-7c for operation at higher frequencies.

The microchannels may be formed within a polymer substrate, for example made of COC (cyclic olefin copolymer), wherein the continuous phase (for example non-polar oil) exhibits more intense wetting properties than the phase to be dispersed (for example water). Thus, the water plug must be actively drawn from the central channel 130 by means of centrifugal force, against the force F_{σ} of the surface tension. At smaller rotational frequencies, the water plug thus rests in the central channel, so that the work area above which a drop formation takes place comprises a lower cut-off frequency ν_{low}. Above this lower cut-off frequency, the water plug exits the central channel and breaks away as soon as the mass of the droplet exceeds a critical mass. The upper boundary of the work area ν_{high} is determined by the point where the drops begin to touch one another and to intergrow because of the drop diameter d and the drop spacing Δ. In this respect, in FIGS. 7d and 7e, the operation is above the cut-off frequency for producing individually separate drops, since a contact between drops, see reference numeral 170, or intergrowth of drops, see reference numeral 172, has occurred there.

With regard to drop generation, one may establish that the droplet generation process is influenced by the hydrodynamic resistances R_{c}, R_{d} and Rₒᵤₜ, the radial positions of the supply channels and of the outlet channel, as well as by the geometry of the drop-carrying channel and the rotational speed. The channel geometries and rotational speeds which are to be used for different fluids for producing emulsions or foams may be readily determined by appropriate calculations or simulations on the part of those skilled in the art.

An example of a possibility of further processing the generated drops on the rotating platform is depicted in FIGS. 8a and 8b. A drop-carrying channel 180, which may be formed, e.g., through the region 150 in FIG. 5, transitions into a fluid channel 182 whose radially outer end leads into a second contact region 184. In addition, radially outer ends of supply channels 186 and 188 lead into the further contact region 184. A continuous phase Φ_{c} is supplied via the supply channels 186 and 188, while an emulsion containing drops 140 is supplied via the channel 182. Thus, the continuous phase Φ_{c} acts upon drop 140′, located within the contacting region 184, from the outside, so that this drop may be divided into two separate drops 190. This process, too, is initiated by a sheath-flow structure and may be controlled in a precise manner. In accordance with FIG. 8b, the frequency is adjusted to be slightly too high, since no proper division into two drops takes place there, but rather an additional satellite drop is produced.

The inventive method for droplet formation was examined using surfactant-free sunflower oil and ink-dyed water (2% by volume).

Two parameters, a characteristic droplet surface area A and the droplet spacing Δ, the latter being a measure of the droplet production rate, were evaluated experimentally. The diameters d as well as the volumes of the droplets were partially approximated from A, since the droplets were squeezed between the upper and lower channel walls, partly to an unknown extent, the channel comprising a depth of about 200 μm.

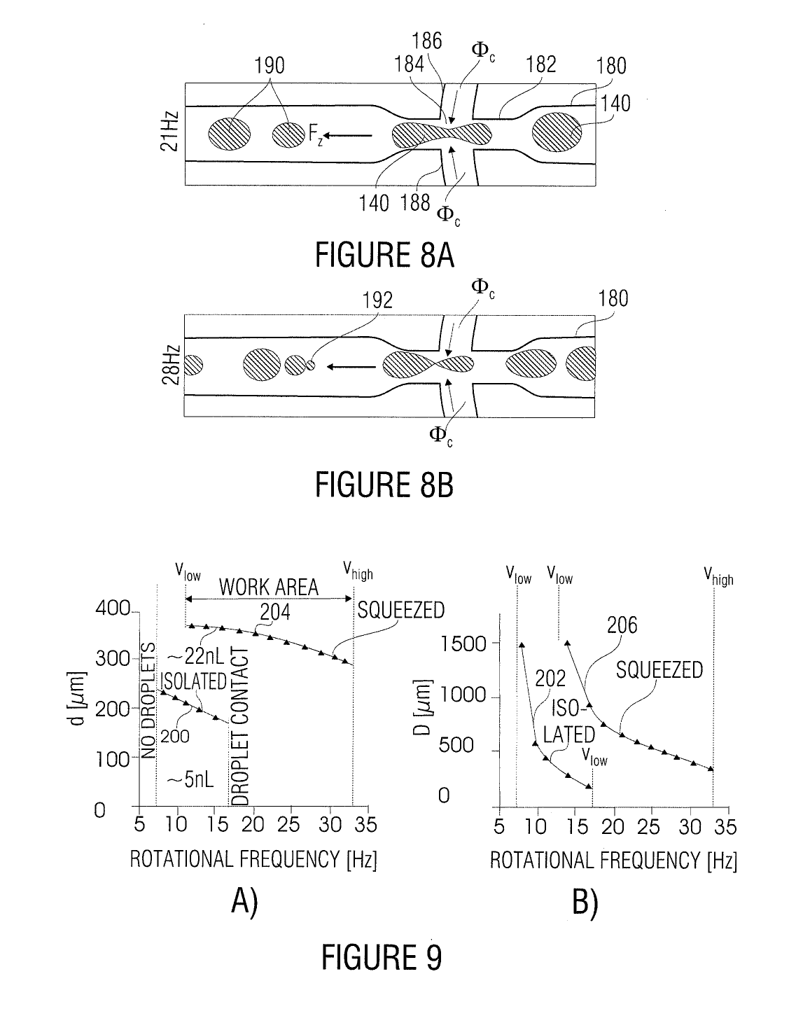

By varying the design of the structure, it was possible to realize three different functions. In this respect, fully free-flowing and isolated droplets may be produced using a high Φ_{c} and a low Rₒᵤₜ. Vertically squeezed droplet trains may be realized using a low flow rate Φ_{c} and a high Rₒᵤₜ, while a segmented flow may be implemented by a narrowing in the droplet-carrying channel. As was already set forth, it is also the frequency of the rotation, in addition to the channel geometry, which influences the spacing and the diameter of the droplet, the droplet generation rate increasing, and its size decreasing, as the rotational frequencies increase. The pertinent results for the droplet diameter d and the droplet spacing Δ are shown in FIGS. 9a and 9b as a function of the rotational frequency ν. The curves 200 and 202 relate to isolated droplets, whereas the curves 204 and 206 relate to squeezed droplets.

Thus, the present invention provides a device and a method enabling the production of monodisperse droplet trains (CV<2%). The experiments conducted enable droplet generation with droplet volumes between 5 and 22 nL within one work area, it being possible for their sizes and spacings to be controlled by channel geometry and rotational frequency. In addition, the present invention enables a further important operation, namely hydrodynamic division of droplets. The centrifugal platform also enables new functions in multiphase-microfluid applications, particular emphasis being placed on sedimentation in this context.

Exemplary post-processing of mixtures produced in accordance with the invention may include polymerization of dispersed drops, which may lead to solid/liquid emulsions having monodisperse solid-phase particles.

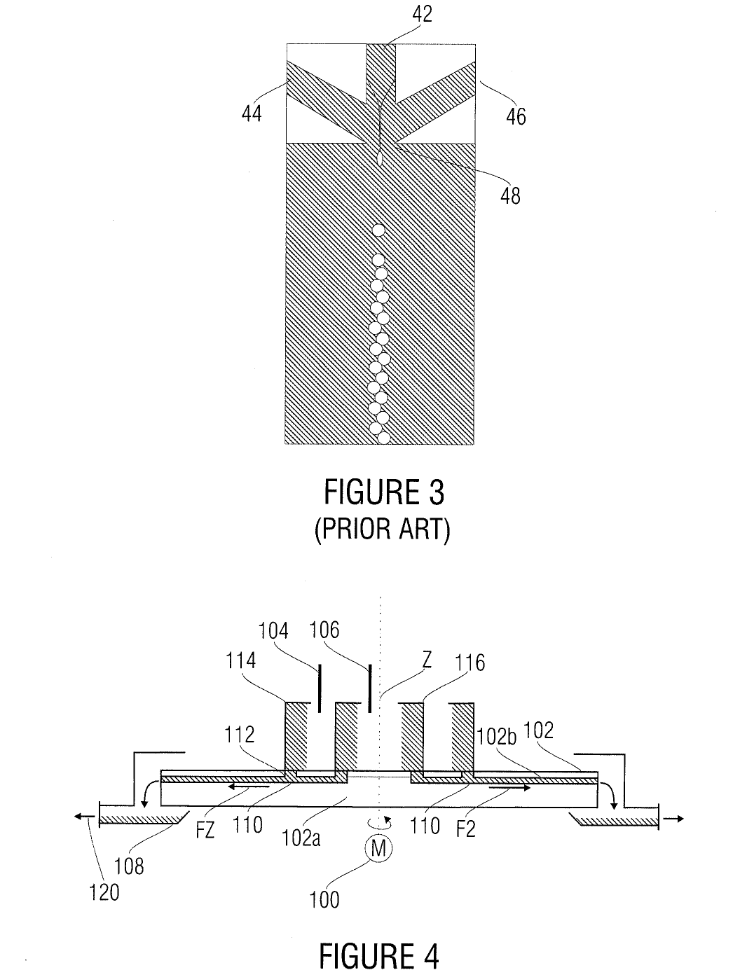

Advantageous embodiments were explained above with reference to a so-called sheath-flow channel structure. However, the present invention is not limited to such a channel structure, but may also be implemented using alternative channel structures which enable detachment of droplets, for example by a T-shaped channel structure as is depicted in FIG. 2 of the present application.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device for producing a mixture of two phases that are insoluble in each other, comprising:
a first fluid channel leading into a contact region;
a second fluid channel leading into the contact region;
a third fluid channel leading into the contact region; and
a rotation imparter adapted to impart a rotation on the first fluid channel, the second fluid channel and the third fluid channel, a first phase being centrifugally supplied to the contact region through the first fluid channel, and a second phase, insoluble in the first phase, being supplied to the contact region through the second fluid channel, compressive and/or shearing forces in the contact region which are centrifugally/hydrodynamically induced by the rotation causing drops to break away in one of the phases supplied in order to produce the mixture of the first and second phases.

2. The device as claimed in claim 1, further comprising a fourth fluid channel which leads into the contact region, the second fluid channel leading into the contact region between the first and fourth fluid channels, so that a phase flow from the first and fourth fluid channels encounters a phase flow from the second fluid channel from opposite sides, which results in drops breaking away from the phase flow from the second fluid channel.

3. The device as claimed in claim 1, further comprising an apportioner for apportioning at least one of the phases into an inlet region of at least one of the fluid channels during the rotation.

4. The device as claimed in claim 1, further comprising an up-taker for continuously taking up the mixture produced from the third fluid channel.

5. The device as claimed in claim 1, wherein the fluid channels are formed within a module, the mixture being radially ejected from the module, and the device further comprising a collector for collecting the mixture radially ejected from the module.

6. The device as claimed in claim 1, wherein the fluid channels are formed within a module, and wherein the module is inserted into a rotor, or wherein the module is a rotor.

7. The device as claimed in claim 6, wherein the rotor comprises a take-up reservoir for taking up the mixture produced.

8. The device as claimed in claim 6, wherein the rotor comprises a plurality of channel structures of first, second, third and, if present, fourth fluid channels which are arranged in a star-shaped manner from a radially inner region to a radially outer region of same.

9. The device as claimed in claim 1, wherein a radially outer end of the third fluid channel leads into a further contact region, into which also the radially outer end of at least one further fluid channel leads, so that centrifugally/hydrodynamically induced compressive and/or shearing forces caused by the rotation in the further contact region result in a further splitting-up of the drops within the mixture supplied through the third fluid channel.

10. The device as claimed in claim 1, wherein a radially outer end of the third fluid channel leads into a further contact region, into which also the radially outer end of at least one further fluid channel leads, so that centrifugally/hydrodynamically induced compressive and/or shearing forces caused by the rotation in the further contact region result in the creation of a mixture of the mixture of the first and second phases as well as of a third phase supplied via the at least one further fluid channel.

11. The device as claimed in claim 1, wherein the phases are liquids, the device being adapted such that the phases are centrifugally supplied to the contact region or regions.

12. The device as claimed in claim 1, wherein one of the phases is a gas, the device further comprising a supplier for supplying the gas to the contact region or regions through the fluid channel or channels.

13. A method for producing a mixture of two phases that are insoluble in each other, comprising:
centrifugally supplying a first phase to the contact region through a first fluid channel;
supplying a second phase to a contact region through a second fluid channel,
the centrifugal supplying being effected by a rotation of the first fluid channel, the second fluid channel and the contact region, compressive and/or shearing forces in the contact region which are centrifugally/hydrodynamically induced by the rotation causing drops to break away in one of the phases supplied in order to produce the mixture of the first and second phases; and
centrifugally draining off the mixture from the contact region through a third fluid channel.

14. The method as claimed in claim 13, further comprising supplying a third phase to the contact region through a fourth fluid channel, the second fluid channel leading into the contact region between the first fluid channel and the fourth fluid channel, so that a phase flow from the first and fourth fluid channels encounters a phase flow from the second fluid channel from opposite sides, which results in drops breaking away from the phase flow from the second fluid channel.

15. The method as claimed in claim 13, further comprising apportioning at least one of the phases into inlet regions of at least one of the fluid channels during the rotation.

16. The method as claimed in claim 13, further comprising transporting the generated mixture into a take-up reservoir by means of centrifugal force.

17. The method as claimed in claim 13, further comprising centrifugally supplying the mixture to a further contact region through the third fluid channel, and centrifugally supplying a further phase to the further contact region, so that centrifugally/hydrodynamically induced compressive and/or shearing forces caused by the rotation in the further contact region result in a further splitting-up of the drops within the mixture supplied through the third fluid channel.

18. The method as claimed in claim 13, further comprising centrifugally supplying the mixture to a further contact region through the third fluid channel, and centrifugally supplying a further phase to the further contact region, so that centrifugally/hydrodynamically induced compressive and/or shearing forces caused by the rotation in the further contact region result in the creation of a mixture of the mixture of the first and second phases as well as of the further phase.

19. The method as claimed in claim 13, wherein a combination of two miscible or immiscible phases is supplied to the contact region through the second fluid channel, so that multi-phase drops are produced in the contact region.

20. The method as claimed in claim 13, wherein the phases are liquids which are centrifugally supplied to the contact region or regions through the fluid channels, so that the mixture represents an emulsion.

21. The method as claimed in claim 13, wherein one phase is a liquid, and one phase is a gas, so that the mixture represents a foam.
